(19) United States
(12) Patent Application Publication
(10) Pub. No.: US 2026/0249125 A1
(43) Pub. Date: Aug. 27, 2026

(54) METHOD AND SYSTEM FOR DEGRADATION OF PERFLUOROOCTANE SULFONATE

(71) Applicant: Beijing Jiaotong University, Beijing (CN)

(72) Inventor: Tong WANG, Beijing (CN)

(21) Appl. No.: 19/648,022

(22) Filed: Apr. 15, 2026

(30) Foreign Application Priority Data
Mar. 17, 2026 (CN) 202610323991.X

(51) Int. Cl. A62D 3/40; A62D 3/30; A62D 101/22; A62D 101/28; B01J 21/04; B01J 21/08

(52) U.S. Cl. CPC A62D 3/40; A62D 3/30; B01J 21/04; B01J 21/08; A62D 2101/22; A62D 2101/28

(57) ABSTRACT

A method for degradation of perfluorooctane sulfonate (PFOS), in which a PFOS-containing sample is mixed with a catalyst to give a mixture, and the mixture is subjected to pyrolysis reaction at 300-700° C. under an inert atmosphere in a pyrolysis reactor, where the generated gaseous products are monitored and analyzed in real time through an online pyrolysis-gas chromatograph-mass spectrometer. A system is also provided for performing such method, including a mixing unit, a pyrolysis reactor, a control unit, a gas supply unit and the online pyrolysis gas-chromatography-mass spectrometer.

### CROSS-REFERENCE TO RELATED APPLICATIONS

This application claims the benefit of priority from Chinese Patent Application No. 202610323991.X, filed on Mar. 17, 2026. The content of the aforementioned application, including any intervening amendments thereto, is incorporated herein by reference in its entirety.

### TECHNICAL FIELD

This application relates to treatment of organic pollutants, and more particularly to a method and system for degradation of perfluorooctane sulfonate (PFOS).

### BACKGROUND

Perfluorooctane sulfonic acid and perfluorooctane sulfonate (PFOS) have been listed in the Persist Organic Pollutants of the Stockholm Convention due to their exceptional chemical stability, bioaccumulation potential and multiple toxicities.

High-temperature incineration is currently the predominant treatment method for PFOS. This process is typically characterized by holding at 1100° C. or more under the exposure to sufficient oxygen for a relatively long period to fully mineralize PFOS into HF, CO₂, and SO_{X}. However, it has inherent limitations of high energy consumption, HF-induced equipment corrosion, and substantial operational costs. More critically, improper control of thermal conditions, such as temperature and mixing degree, will lead to incomplete combustion, thereby leading to the generation of highly-toxic intermediates like perfluoroisobutylene (PFIB) and causing severe secondary pollution.

It has been reported that the non-catalytic pyrolysis of PFOS under inert atmosphere begins at approximately 300° C., and within the range of 500-700° C., the pyrolysis process is complex and incomplete, leading to the formation of various toxic compounds, such as perfluoroisobutylene and perfluorooctanoic acid (PFOA).

To this regard, it is urgently needed to develop a novel technical strategy to regulate the PFOS pyrolysis pathway, so as to enable controlled and complete decomposition at a relatively lower temperature and effectively suppress the formation of hazardous by-products.

### SUMMARY

In view of this, there is an urgent need to provide a method and system for degradation of perfluorooctane sulfonate (PFOS), so as to address the technical problems in the prior art.

In order to achieve the above object, the present disclosure adopts the following technical solutions.

A method for degradation of perfluorooctane sulfonate (PFOS), comprising:
mixing a PFOS-containing sample with a catalyst to give a mixture; and
subjecting the mixture to a pyrolysis reaction at 300-700° C. under an inert atmosphere in a pyrolysis reactor.

In some embodiments, the catalyst is selected from the group consisting of alumina, silicon dioxide and a combination thereof.

In some embodiments, the catalyst is acid-modified alumina.

In some embodiments, a weight ratio of the PFOS-containing sample to the catalyst is 1:1-10.

In some embodiments, gaseous products generated during the pyrolytic reaction are selected from the group consisting of sulfur dioxide, fluoroalkanes, fluoroalkenes, perfluorocycloalkanes, carbon disulfide and a combination thereof.

In some embodiments, the gaseous products generated during the pyrolytic reaction are monitored and analyzed in real time through an online pyrolysis-gas chromatograph-mass spectrometer, wherein the online pyrolysis-gas chromatograph-mass spectrometer is configured to perform qualitative or semi-quantitative analysis of short-chain perfluorocarboxylic acids and perfluorosulfonic acids in the gaseous products.

In some embodiments, the method further comprises treating a PFOS-containing pollutant, and optimizing pyrolysis conditions of PFOS.

In some embodiments, the present disclosure provides a method for optimizing pyrolysis conditions of perfluorooctane sulfonate (PFOS), which is performed through steps of:
(S100) setting at least two parallel test groups, wherein the at least two parallel test groups comprises a first test group and a second test group; the first test group comprises a plurality of first samples, each being a mixture of a PFOS-containing sample and a first catalyst; and the second test group comprises a plurality of second samples, each being a mixture of the PFOS-containing sample and a second catalyst or the PFOS-containing sample;
(S200) subjecting the plurality of first samples to pyrolysis reaction respectively at different preset temperatures in a pyrolysis reactor, and subjecting the plurality of second samples to pyrolysis reaction respectively at different preset temperatures in the pyrolysis reactor;
(S300) collecting and analyzing, by an online pyrolysis-gas chromatography-mass spectrometer, gaseous products in real time during pyrolysis of each sample; and
(S400) based on analysis results generated by the online pyrolysis-gas chromatography-mass spectrometer, comparing and analyzing PFOS decomposition efficiency and distribution of characteristic products of each test group at different temperatures, so as to determine an optimal pyrolysis temperature for individual specific catalysts or non-catalytic conditions.

In some embodiments, the present disclosure provides a system for catalytic pyrolysis of perfluorooctane sulfonate (PFOS), wherein the system is configured for performing the aforementioned method, and the system comprises:
a mixing unit;
a pyrolysis reactor;
a control unit;
a supply unit; and
an online analysis unit;
wherein the mixing unit is configured to mix the PFOS-containing sample with the catalyst to give the mixture;
the pyrolysis reactor is configured to receive the mixture, and perform the pyrolytic reaction under the inert atmosphere;
the control unit is connected to the pyrolysis reactor, and is configured to control a temperature of the pyrolysis reactor;
the supply unit is configured to supply an inert gas to the pyrolysis reactor and maintain the pyrolysis reactor in the inert atmosphere; and
the online analysis unit is the online pyrolysis-gas chromatograph-mass spectrometer, and is configured to monitor and analyze the gaseous products in real time.

In some embodiments, the system further comprises a tail gas treatment unit, wherein the tail gas treatment unit is connected to an outlet of the online analysis unit.

The present disclosure has the following beneficial effects.
(1) This disclosure reduces a temperature for efficient PFOS decomposition to 300-700° C., significantly lower than a temperature (over 1100° C.) required by conventional high-temperature incineration. This substantially decreases energy consumption. The lower operating temperature also reduces reliance on equipment materials with high-temperature and corrosion resistance, thereby effectively lowering both capital investment and operational maintenance costs.
(2) This disclosure integrates the catalytic pyrolysis with the online analysis unit, which enables online qualitative and semi-quantitative analysis of the gaseous products in real time. It achieves immediate assessment of PFOS decomposition efficiency and precisely analyzes and quantifies formation conditions of key fluorinated intermediates, such as short-chain perfluorocarboxylic acids and perfluorosulfonic acids. These capabilities provide data for adjusting reaction parameters in real time to optimize degradation performance and ensure environmental safety.
(3) The method and the system function not only as an efficient PFOS treatment solution but also as a standardized platform for systematically studying PFOS thermochemical behavior, screening and evaluating catalysts, and optimizing process parameters. By comparing product profiles obtained under different catalysts and temperatures, this disclosure delivers a practical technical tool for developing PFOS disposal technologies or optimizing operational parameters of existing industrial incineration facilities.

### BRIEF DESCRIPTION OF THE DRAWINGS

FIG. 1 structurally shows a system for pyrolysis experiment according to an embodiment of the present disclosure;

FIG. 2 is a comparison chart of a relationship between catalyst types and temperatures for complete catalytic pyrolysis according to an embodiment of the present disclosure;

FIG. 3 shows a distribution of main pyrolysis products without a catalyst according to an embodiment of the present disclosure;

FIG. 4 shows a distribution of the main pyrolysis products if the catalyst is Al₂O₃ according to an embodiment of the present disclosure; and

FIG. 5 shows a distribution of the main pyrolysis products if the catalyst is SiO₂ according to an embodiment of the present disclosure.

### DETAILED DESCRIPTION OF EMBODIMENTS

In order to better illustrate the objects, technical solutions and advantages of the present disclosure, this disclosure will be further described with reference to the embodiments.

Unless otherwise specified, the experiments in the following embodiments are performed under conventional conditions or conditions recommended by the manufacturer, and the materials or reagents are all commercially available.

The present disclosure provides a method for degradation of perfluorooctane sulfonate (PFOS), which is performed through the following steps.

A PFOS-containing sample is mixed with a catalyst to give a mixture.

The mixture is subjected to a pyrolysis reaction at 300-700° C. under an inert atmosphere in a pyrolysis reactor.

In some embodiments, gaseous products generated during the pyrolytic reaction are monitored and analyzed in real time through an online pyrolysis-gas chromatograph-mass spectrometer, where the online pyrolysis-gas chromatograph-mass spectrometer is configured to assess the decomposition efficiency of PFOS in real time, and analyze and quantify formation conditions of toxic fluorine-containing intermediate products, so as to provide data for regulating reaction condition and ensuring environmental safety.

In some embodiments, the catalyst is selected from the group consisting of alumina, silicon dioxide and a combination thereof.

In some embodiments, the catalyst is acid-modified alumina.

In some embodiments, the acid-modified alumina is prepared by impregnating Al₂O₃ with a 5-10% nitric acid solution followed by calcination at 500-700° C. to yield γ-Al₂O₃ with abundant surface acid sites.

In some embodiments, a weight ratio of the PFOS-containing sample to the catalyst is 1:1-10.

In some embodiments, the gaseous products are selected from the group consisting of sulfur dioxide, fluoroalkanes, fluoroalkenes, perfluorocycloalkanes, carbon disulfide and a combination thereof.

In some embodiments, the online pyrolysis-gas chromatograph-mass spectrometer is configured to perform qualitative or semi-quantitative analysis of short-chain perfluorocarboxylic acids and perfluorosulfonic acids in the gaseous products.

In some embodiments, the method further includes treating a PFOS-containing pollutant, and optimizing pyrolysis conditions of PFOS.

In some embodiments, the present disclosure provides a method for optimizing pyrolysis conditions of PFOS, which is performed through the following steps.
(S100) At least two parallel test groups are set, where the at least two parallel test groups includes a first test group and a second test group. The first test group includes a plurality of first samples, each being a mixture of the PFOS-containing sample and a first catalyst. The second test group includes a plurality of second samples, each being a mixture of the PFOS-containing sample and a second catalyst or the PFOS-containing sample.
(S200) The plurality of first samples are subjected to pyrolysis reaction respectively at different preset temperatures in a pyrolysis reactor. The plurality of second samples are subjected to pyrolysis reaction respectively at different preset temperatures in the pyrolysis reactor.
(S300) The gaseous products are collected and analyzed in real time during pyrolysis of each sample by the online pyrolysis-gas chromatograph-mass spectrometer.
(S400) Based on analysis results generated by the online pyrolysis-gas chromatograph-mass spectrometer, PFOS decomposition efficiency and distribution of characteristic products of each test group at different temperatures are compared and analyzed, so as to determine an optimal pyrolysis temperature for individual specific catalysts or non-catalytic conditions.

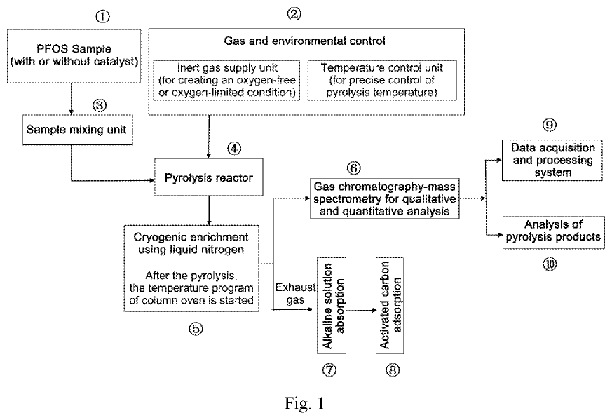

Referring to FIG. 1, the present disclosure provides a system for catalytic pyrolysis of PFOS, including a mixing unit, a pyrolysis reactor, a control unit, a supply unit and an online analysis unit.

The mixing unit is configured to mix the PFOS-containing sample with the catalyst to give the mixture.

The pyrolysis reactor is configured to receive the mixture, and perform the pyrolytic reaction under the inert atmosphere.

The control unit is connected to the pyrolysis reactor, and is configured to control a temperature of the pyrolysis reactor.

The supply unit is configured to supply an inert gas to the pyrolysis reactor and maintain the pyrolysis reactor in the inert atmosphere.

The online analysis unit is the online pyrolysis-gas chromatograph-mass spectrometer, and is configured to monitor and analyze the gaseous products in real time.

In some embodiments, the system further includes a tail gas treatment unit, where the tail gas treatment unit is connected to an outlet of the online analysis unit.

In some embodiments, the mixing unit is configured to fully mix the PFOS-containing sample with the catalyst. In this case, the mixing unit includes a mixer, such as a static mixer or a dynamic mixer.

In some embodiments, the mixing unit includes a mixing chamber provided with a stirring assembly. The mixing chamber is made of a high-temperature resistant and corrosion-resistant material (e.g., 304S stainless steel). The mixing chamber is internally provided with a lifting device to lift slurry. The lifting device includes a rotating shaft, a helical ring and a feeding port, and is powered by an inverter motor, so as to achieve uniform mixing and circulation of materials and ensure that the mixture reaches a homogeneous state before entering the pyrolysis reactor.

In order to precisely control the reaction temperature, the control unit is connected to the pyrolysis reactor. The control unit is configured as a proportional-integral-derivative (PID) controller.

In some embodiments, the control unit includes at least one temperature sensors (e.g., thermocouple) configured for monitoring the temperature of the pyrolysis reactor in real time, and a heating element (e.g., a heating coil). The PID controller automatically adjusts a power output of the heating element based on a difference between a preset temperature and an actual temperature by using its built-in PID algorithm, thereby minimizing temperature fluctuations, maintaining temperature stability, and ensuring that the pyrolytic reaction proceeds precisely at the preset temperature (for example, held constant at 600° C. or other process temperatures).

In some embodiments, the supply unit is configured to supply the inert gas to the system and maintain the pyrolysis reactor in the inert atmosphere. In this case, the supply unit includes an inert gas source (such as nitrogen or argon cylinders), a pressure reducing valve, a mass flow controller (MFC) and a pipeline system. An outlet pipeline of the gas source is provided with a proportional relief valve to ensure a stable system pressure.

In some embodiments, the system employs automatic control, where the gas flow rate is set via software and precisely regulated by the MFC. The pipeline system is made of 316L stainless steel to ensure leak-tightness and corrosion resistance.

In some embodiments, the inert gas supplied by the supply unit is configured to remove air from the system. The PFOS-containing sample is transported into the pyrolysis reactor after mixing in the mixing unit. The control unit is configured to perform programed temperature control of the pyrolysis reactor according to requirements for the pyrolytic reaction. The gaseous products generated during the pyrolytic reaction is analyzed in real time by the online pyrolysis-gas chromatograph-mass spectrometer.

### Embodiment 1 Alumina Catalysis

(1) 1-3 mg of perfluorooctane sulfonate (PFOS) standard sample and 200-mesh γ-alumina powder were transferred into a pyrolysis cup at a weight ratio of 1:5. The pyrolysis cup containing the mixture was then loaded into the pyrolyzer for thermal decomposition.
(2) The pyrolysis temperature of the pyrolyzer was increased stepwise from 300° C. to 700° C. at intervals of 50° C., where the pyrolytic reaction was performed for 10 s at each temperature point. The gaseous products generated during the pyrolytic reaction were monitored and collected in real time by the online pyrolysis-gas chromatograph-mass spectrometer (GC-MS), thereby conducting online analysis. Complete pyrolytic rection was confirmed when characteristic ion fragment signals of PFOS (e.g., m/z 499 and SO₂F⁺) decreased to a background level.

The pyrolyzer was an EGA/PY-3030D model directly connected to the GC-MS system. GC/MS analysis was performed using an Agilent 7890/7000B triple quadrupole gas chromatograph-mass spectrometer. A DB-5 fused silica capillary column (30 m×0.25 mm×0.25 μm, Agilent, USA) was employed with helium as a carrier gas at a constant flow rate of 1.1 mL/min.

The GC oven temperature program was set as follows: held at 40° C. for 5 min, ramped to 100° C. at 2° C./min, then ramped to 290° C. at 4° C./min, and maintained at 290° C. for 30 min.

Mass spectrometry parameters were configured with an ionization energy of 70 eV, an ion source temperature of 230° C., and a scan mass range of 10-550 amu.

Compound identification was determined by integrating product characteristic ions, relative retention times, and spectral matching against NIST 11 database.

The γ-Al₂O₃ catalyst was prepared by impregnating Al₂O₃ with a 10 wt. % nitric acid solution followed by calcination at 600° C. to yield γ-Al₂O₃ with abundant surface acid sites.

### Embodiment 2 Silicon Dioxide Catalysis

All steps were the same as in Embodiment 1, with the exception that the 200-mesh γ-alumina powder was replaced with an equal quantity of 200-mesh acidic silica gel powder.

### Comparative Example 1 without Catalyst

All procedures followed the protocols in Embodiment 1, except no 200-mesh γ-alumina powder was added.

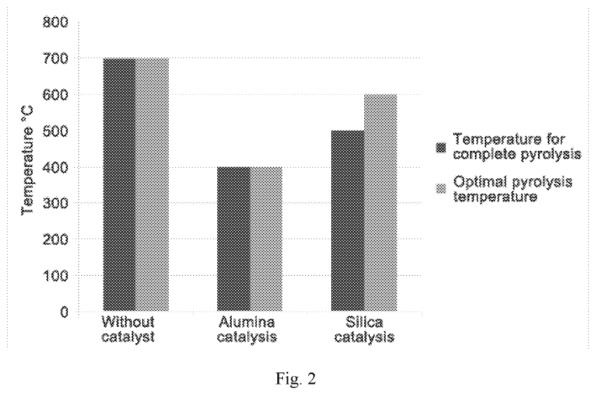

The relationship between catalyst types and temperatures for complete pyrolytic reaction obtained from Embodiment 1, Embodiment 2, and Comparative Example 1 was illustrated in FIG. 2. Referring to FIG. 2, it was observed that the temperature for complete pyrolytic reaction was 400° C. in Embodiment 1 (with Al₂O₃ catalysis); it was 500° C. in Embodiment 2 (with SiO₂ catalysis); and it was 700° C. in Comparative Example 1 (without catalyst).

### Experimental Example 1

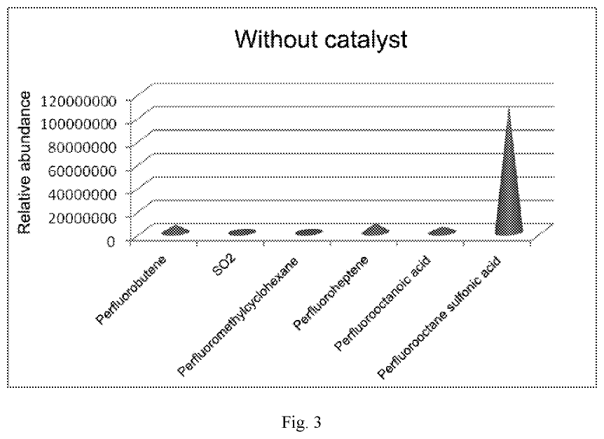

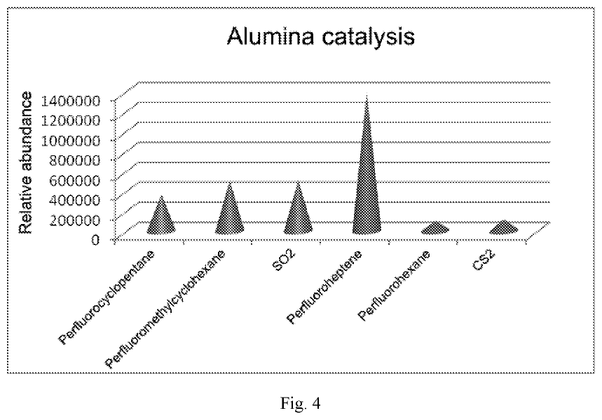

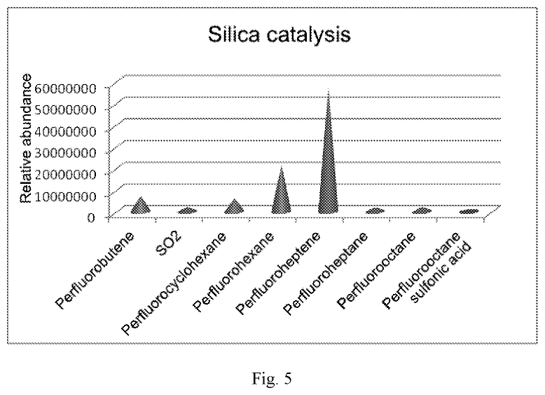

PFOS pyrolysis experiments were conducted under three conditions: without catalyst, with alumina catalysis, and with silica gel catalysis. The temperature of pyrolytic reaction was fixed at 500° C. for 5 min, and all other experimental steps were consistent with those described in Embodiment 1. In an absence of a catalyst, the distribution of main pyrolysis products was shown in FIG. 3; when Al₂O₃ was used as the catalyst, the product distribution was depicted in FIG. 4; and when SiO₂ was used as the catalyst, the product distribution was presented in FIG. 5.

Referring to FIG. 3, it could be seen that without catalysis, the detected products included perfluoroisobutylene, SO₂, methyl perfluorocyclohexane, perfluoroheptene, perfluorooctanoic acid, and significant un-degraded PFOS characteristic peaks indicated incomplete pyrolytic reaction with complex pathway and the formation of unsaturated alkenes.

Referring to FIG. 4, it revealed that when Al₂O₃ was used as the catalyst, the detected products included perfluorocyclopentane, methyl perfluorocyclohexane, SO₂, CS₂, perfluorohexane, and perfluoroheptene. Neither perfluoroisobutylene nor PFOS residues were detected, demonstrating notable cyclization (formation of cyclopentane) and deep desulfurization (generation of CS₂).

Referring to FIG. 5, when SiO₂ was used as the catalyst, the detected products included perfluorobutene, perfluoroheptene, perfluorohexane, perfluoroheptane, perfluorooctane, SO₂, perfluorocyclohexane, and trace amounts of PFOS residue, primarily consisting of straight-chain perfluoroalkanes/alkenes of varying carbon chain lengths.

Based on the results of Embodiment 1, Embodiment 2, Comparative Example 1, and Experimental Example 1, it could be concluded that both Al₂O₃ and SiO₂ catalysts exhibited significant effectiveness in reducing the pyrolysis temperature of PFOS and controlling the distribution of pyrolysis products.

It should be noted that the specific parameters and reagents described in the above embodiments are merely illustrative, and not intended to limit this present disclosure. Obviously, described above are merely some embodiments of the present disclosure, not all embodiments. Any modifications made by those skilled in the art without departing from the spirit of the disclosure shall fall within the scope of the disclosure defined by the appended claims.

What is claimed is:

1. A method for degradation of perfluorooctane sulfonate (PFOS), comprising:
mixing a PFOS-containing sample with a catalyst to give a mixture; and
subjecting the mixture to a pyrolysis reaction at 300-700° C. under an inert atmosphere in a pyrolysis reactor;
wherein gaseous products generated during the pyrolytic reaction are monitored and analyzed in real time through an online pyrolysis-gas chromatograph-mass spectrometer.

2. The method of claim 1, wherein the catalyst is selected from the group consisting of alumina, silicon dioxide and a combination thereof.

3. The method of claim 1, wherein the catalyst is acid-modified alumina.

4. The method of claim 3, wherein a weight ratio of a perfluorooctane sulfonate-containing sample to the catalyst is 1:1-10.

5. The method of claim 1, wherein the gaseous products are selected from the group consisting of sulfur dioxide, fluoroalkanes, fluoroalkenes, perfluorocycloalkanes, carbon disulfide and a combination thereof.

6. The method of claim 1, wherein the online pyrolysis-gas chromatograph-mass spectrometer is configured to perform qualitative or semi-quantitative analysis of perfluorocarboxylic acids and perfluorosulfonic acids in the gaseous products.

7. A method for optimizing pyrolysis conditions of perfluorooctane sulfonate (PFOS), comprising:
(S100) setting at least two parallel test groups, wherein the at least two parallel test groups comprises a first test group and a second test group; the first test group comprises a plurality of first samples, each being a mixture of a PFOS-containing sample and a first catalyst; and the second test group comprises a plurality of second samples, each being a mixture of the PFOS-containing sample and a second catalyst or the PFOS-containing sample;
(S200) subjecting the plurality of first samples to pyrolysis reaction respectively at different preset temperatures in a pyrolysis reactor, and subjecting the plurality of second samples to pyrolysis reaction respectively at different preset temperatures in the pyrolysis reactor;
(S300) collecting and analyzing, by an online pyrolysis-gas chromatography-mass spectrometer, gaseous products in real time during pyrolysis of each sample; and
(S400) based on analysis results generated by the online pyrolysis-gas chromatography-mass spectrometer, comparing and analyzing PFOS decomposition efficiency and distribution of characteristic products of each test group at different temperatures, so as to determine an optimal pyrolysis temperature for individual specific catalysts or non-catalytic conditions.

8. A system for catalytic pyrolysis of perfluorooctane sulfonate (PFOS), the system being configured for performing the method of claim 1, and the system comprising:
a mixing unit;
a pyrolysis reactor;
a control unit;
a supply unit; and
an online analysis unit;
wherein the mixing unit is configured to mix the PFOS-containing sample with the catalyst to give the mixture;
the pyrolysis reactor is configured to receive the mixture, and perform the pyrolytic reaction under the inert atmosphere;
the control unit is connected to the pyrolysis reactor, and is configured to control a temperature of the pyrolysis reactor;
the supply unit is configured to supply an inert gas to the pyrolysis reactor and maintain the pyrolysis reactor in the inert atmosphere; and
the online analysis unit is the online pyrolysis-gas chromatograph-mass spectrometer, and is configured to monitor and analyze the gaseous products in real time.

9. The system of claim 8, further comprising:
a tail gas treatment unit;
wherein the tail gas treatment unit is connected to an outlet of the online analysis unit.
